(19) United States
(12) Patent Application Publication
(10) Pub. No.: US 2022/0034720 A1
(43) Pub. Date: Feb. 3, 2022

(54) BOLOMETER AND METHOD FOR MANUFACTURING SAME

(71) Applicant: NEC Corporation, Tokyo (JP)

(72) Inventor: Tomo TANAKA, Tokyo (JP)

(73) Assignee: NEC Corporation, Tokyo (JP)

(21) Appl. No.: 17/386,574

(22) Filed: Jul. 28, 2021

(30) Foreign Application Priority Data
Jul. 28, 2020 (JP) 2020-127794

(51) Int. Cl. G01J 5/08; G01J 5/24; G01J 5/02

(52) U.S. Cl. CPC G01J 5/0853; G01J 5/023; G01J 5/24

(57) ABSTRACT

An example objective of the present invention is to provide a bolometer capable of reducing its manufacturing cost. A bolometer according to an example aspect of the present invention includes: a substrate; a heat insulating layer formed on the substrate; and a bolometer film formed on the heat insulating layer; wherein the bolometer film is a carbon nanotube film including semiconducting carbon nanotubes in an amount of 67% by mass or more of the total amount of carbon nanotubes, and the thickness of the carbon nanotube film is in the range of 10 nm to 1 μm, and the density of the carbon nanotube film is 0.3 g/cm³ or more.

This application is based upon and claims the benefit of priority from Japanese patent application No. 2020-127794, filed on Jul. 28, 2020, the disclosure of which is incorporated herein in its entirety by reference.

### TECHNICAL FIELD

The present invention relates to a bolometer using carbon nanotubes and a method for manufacturing the same

### BACKGROUND ART

Infrared sensors have a very wide range of applications such as not only monitoring cameras for security, but also thermography for human body, in-vehicle cameras, and inspection of structures, foods, and the like, and are thus actively used in industrial applications in recent years. In particular, development of a low-cost and high-performance infrared sensor capable of obtaining biological information in cooperation with IoT (Internet of Thing) is expected.

A bolometer, which is one of the uncooled infrared sensors, has various applications as an inexpensive infrared sensor. An example of the cell structure of a bolometer is explained with reference to FIGS. 10A and 10B. This bolometer has a diaphragm-type heat-insulating unit 4 on a silicon substrate 1, which is separated from the silicon substrate 1 by a gap 7 with a leg 42 as a support, and has an infrared detection part 3 on the heat-insulating unit 4. When irradiated with infrared rays, the infrared detection part 3 is heated and detects the resistance change caused by temperature change. In such a bolometer, vanadium oxide is used as a bolometer film of the infrared detection part 3, and silicon nitride (SiN) is used for the base part of the diaphragm-type heat-insulating unit 4 and as a coating material for the bolometer film. However, since the thicknesses of SiN and vanadium oxide are optimized for detectability as a bolometer, and the infrared light absorption is not sufficient, there is employed a structure in which an infrared reflection film 6 is provided to reflect the light once transmitted through the bolometer film and make the light incident into the bolometer film again (Patent Document 1). In some cases, the light absorption is still not sufficient with such a structure alone, and a light absorbing film is additionally provided directly above the bolometer film.

The silicon MEMS (Micro Electro Mechanical Systems) process is usually used to fabricate such structures. In the MEMS process, as shown in FIGS. 11A to 11D, a readout circuit is constituted with a CMOS (Complementary Metal Oxide Semiconductor) transistor and the like in a semiconductor substrate 801, and an interlayer insulating film 820 is formed thereon by the CVD method, and a metal infrared reflection film 804, an interlayer insulating film 820, and a sacrificial layer 830 are formed on its upper layer (FIG. 11A). Thereafter, a diaphragm film consisting of a silicon nitride film 831 and a silicon oxide film 832 is formed by the CVD method, and a metal electrode 805 is formed on the diaphragm film (FIG. 11B). Next, a thermistor resistor (bolometer film) 806 connected to a metal electrode 805, a second silicon nitride film 833, and an infrared absorption film 811 are formed (FIG. 11C). Finally, the sacrificial layer 830 is removed by etching to obtain a cell with a diaphragm structure (FIG. 11D). As shown in FIG. 12, an additional infrared absorbing structure 811, which is called “eave”, may be provided in order to efficiently absorb the infrared ray incident into the pixels. Thus, as described hereto, the manufacturing of bolometers such as those shown in FIGS. 10A and 10B and FIG. 12 has the problem of requiring a complicated manufacturing method.

In addition, there is a problem that the performance of vanadium oxide, which is mainly used for bolometer films, is limited by its low Temperature Coefficient of Resistance (TCR). In order to improve performance, it is required to use a material with a higher TCR for the bolometer thin film, and a random network of semiconducting carbon nanotubes (CNT), which is a material with a high TCR, is expected to be used as the bolometer film (Patent Documents 2 and 3).

However, when carbon nanotubes are used as the bolometer film, there is a problem that the manufacturing process becomes more complicated because the element structure cannot be fabricated only with ordinary semiconductor process, and this leads to higher costs, especially when pixels need to be integrated into an array sensor for image acquisition. In addition, even when carbon nanotubes were used as the bolometer film, there was still room for improvement in terms of infrared absorption rate.

### CITATION LIST

### Patent Literature

Patent Document 1: Japanese Patent Laid-Open No. 2007-263769

Patent Document 2: International publication No. WO 2012/049801

Patent Document 3: International publication No. WO 2011/145295

### SUMMARY OF INVENTION

### Technical Problem

The present invention was made in view of the above problem, and an example object thereof is to provide a bolometer capable of reducing its manufacturing cost, and a method for manufacturing the same.

### Solution to Problem

One aspect of the present invention is directed to a bolometer comprising

a substrate;

a heat insulating layer formed on the substrate; and

a bolometer film formed on the heat insulating layer; wherein

the bolometer film is a carbon nanotube film comprising semiconducting carbon nanotubes in an amount of 67% by mass or more of the total amount of carbon nanotubes, and

the thickness of the carbon nanotube film is in the range of 10 nm to 1 μm, and the density of the carbon nanotube film is 0.3 g/cm³ or more.

Another aspect of the present invention is directed to a method for manufacturing a bolometer comprising

forming a heat insulating layer on a substrate, and

forming a bolometer film on the heat insulating layer; wherein

the bolometer film is a carbon nanotube film comprising semiconducting carbon nanotubes in an amount of 67% by mass or more of the total amount of carbon nanotubes, and

the thickness of the carbon nanotube film is in the range of 10 nm to 1 μm, and the density of the carbon nanotube film is 0.3 g/cm³ or more.

### Advantageous Effect of Invention

According to the present invention, a bolometer capable of reducing its manufacturing cost and a method for manufacturing the same can be provided.

### BRIEF DESCRIPTION OF DRAWINGS

FIGS. 1A and 1B show the structure of a bolometer according to an embodiment of the present invention. FIG. 1A is a plan view, and FIG. 1B is a cross-sectional view along the line A-A′ of FIG. 1A.

FIG. 2 is a vertical sectional front view showing the structure of a bolometer according to an embodiment of the present invention.

FIGS. 3A and 3B are a vertical sectional front view showing the structure of a bolometer according to an embodiment of the present invention.

FIG. 4 is a plan view of the structure of a bolometer array according to an embodiment of the present invention.

FIGS. 5A to 5D are a vertical sectional front view showing a method of manufacturing a bolometer.

FIGS. 6A to 6C are a process chart showing a method for manufacturing a bolometer array of an embodiment of the present invention.

FIG. 7 is a plan view showing the structure of a bolometer array according to an embodiment of the present invention.

FIG. 8 is a plan view showing the structure of a bolometer array according to an embodiment of the present invention.

FIGS. 9A and 9B show the structure of a bolometer array according to an embodiment of the present invention. FIG. 9A is a vertical sectional front view, and FIG. 9B is a pixel circuit.

FIGS. 10A and 10B show the structure of a conventional bolometer. FIG. 10A is a perspective view, and FIG. 10B is a vertical sectional front view.

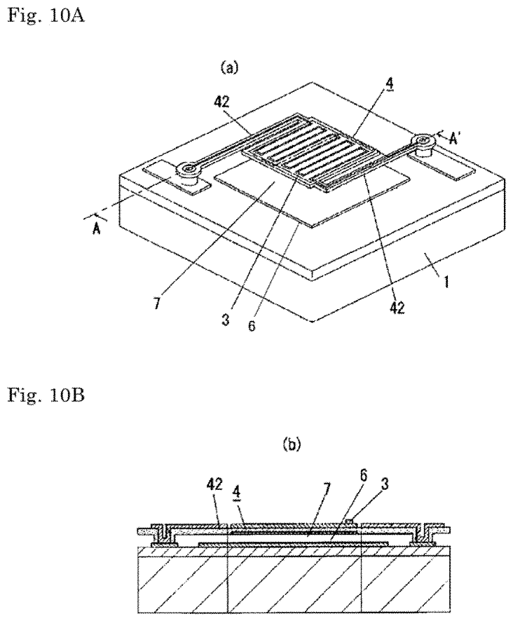

FIGS. 11A to 11D are a process chart showing a method for manufacturing a conventional bolometer.

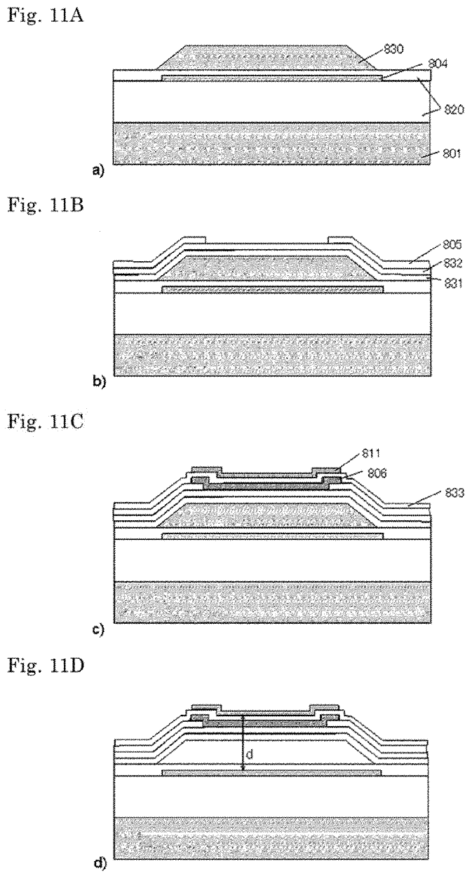

FIG. 12 is a vertical sectional front view showing the structure of a conventional bolometer.

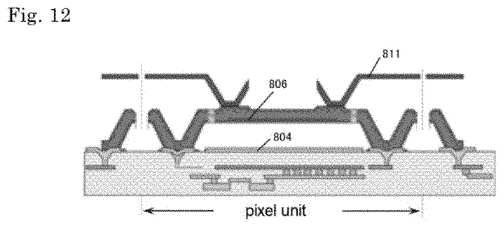

### DESCRIPTION OF EMBODIMENTS

### Structure of Bolometer

Embodiments of the present invention will be described with reference to the drawings. However, parts that are identical to the conventional example described above may be omitted from the detailed description by using the same name. In the following embodiments, a bolometer that detects infrared light (i.e., an infrared sensor) will be used as an example for explanation, but the bolometer of the present embodiment can also be used to detect, for example, terahertz waves in addition to infrared light, as will be described later. Therefore, as used herein, the terms “infrared ray” and “infrared light” can be read as appropriate for a desired electromagnetic wave to be detected.

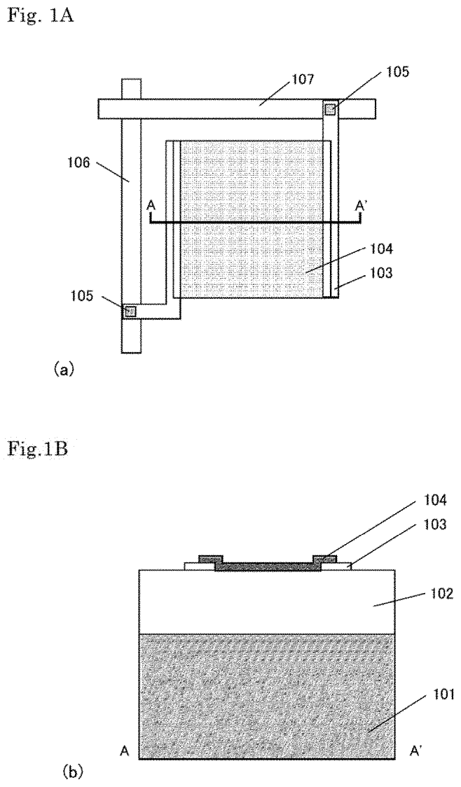

The structure of the bolometer according to one embodiment of the present invention is shown in FIGS. 1A and 1B. FIG. 1A is a plan view and FIG. 1B is an A-A′ cross-sectional view of FIG. 1A. In the bolometer of the present embodiment, a heat insulating layer 102 is provided on a substrate 101, and a bolometer film 104, which is a predetermined carbon nanotube film described later, is provided on the heat insulating layer 102. Electrodes 103 provided so as to contact with the carbon nanotube film 104 are connected via contacts 105 to a column wiring 107 and a row wiring 106 which are insulated each other. Such a bolometer detects the intensity of an infrared ray by reading out the resistance change due to the temperature increase of the bolometer film.

In the structure shown in FIG. 1B, when an infrared ray is incident from above, if the conventional vanadium oxide is used as the bolometer film 104, most of the incident infrared ray is not absorbed and passes through the bolometer film, and therefore, an infrared reflection layer (light reflection layer) should be provided between the bolometer film 104 and the substrate 101. However, in the bolometer of the present embodiment, the absorption rate of infrared light can be increased by using a predetermined carbon nanotube film, which will be described later, as the bolometer film 104. Therefore, it is not necessarily to provide a light reflection layer or the like, and the element structure can be further simplified.

In addition, in the bolometer of the present embodiment, the bolometer film 104 and the substrate 101 are thermally separated by the heat insulating layer 102, which prevents heat from escaping from the bolometer film 104 and improves detection sensitivity. Furthermore, the element structure is simpler than that of a conventional bolometer of a diaphragm-type structure having a gap between the substrate 101 and the bolometer film 104, and vacuum packaging to evacuate the gap is not required.

Furthermore, since these carbon nanotube film 104 and heat insulating layer 102 can be fabricated using printing technology, the manufacturing cost can be lowered as compared to the case of using the MEMS process described above.

The bolometer of the present invention comprises, as described above, a predetermined carbon nanotube film as a bolometer film, and a heat insulating layer, but is not limited to the above-described embodiments.

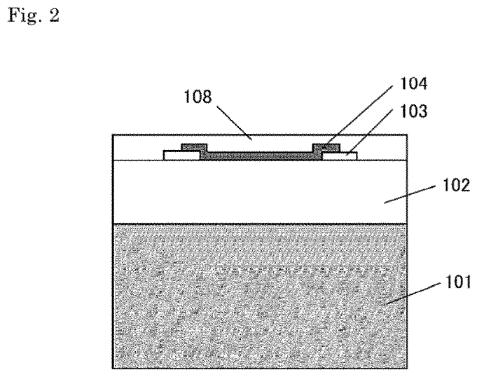

For example, in the embodiment shown in FIG. 2, a protection layer 108 is provided on the carbon nanotube film 104. The protection layer has effects of suppressing doping to carbon nanotubes due to the absorption of oxygen or the like, and of increasing the infrared absorption rate, which is because not only the carbon nanotubes but also the protection layer absorbs infrared ray

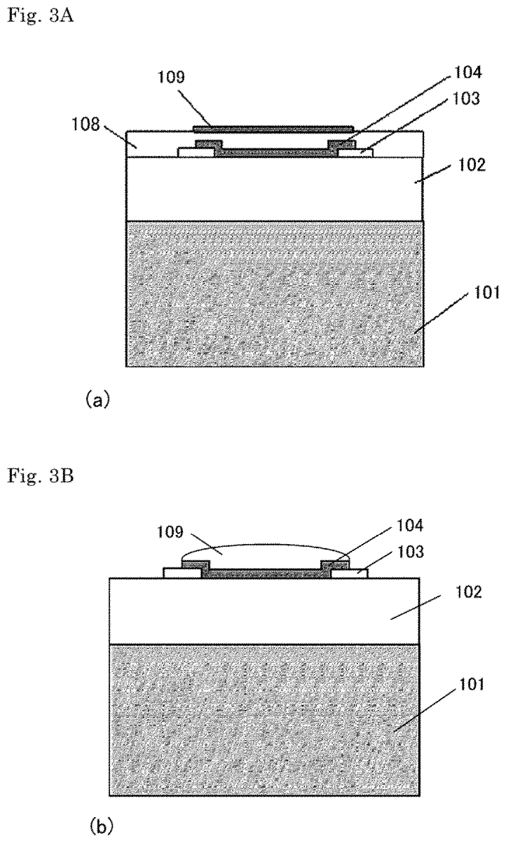

The bolometer of the present embodiment does not necessary require an infrared absorbing layer (light absorbing layer) because a desired carbon nanotube film having a high light absorption rate is used as the bolometer film, and therefore, the bolometer according to one embodiment of the present invention does not comprise any light absorbing layer as shown in FIGS. 1A and 1B; however, an infrared absorbing layer may be comprised as desired. In the embodiment shown in FIGS. 3A and 3B for example, an infrared absorbing layer (light absorbing layer) 109 is provided above the carbon nanotube film 104, namely, on the side from which an infrared ray is incident. The infrared absorbing layer may be provided on the aforementioned protection layer 108 (FIG. 3A), or may be provided directly on the carbon nanotube film 104 (FIG. 3B).

In addition, as described above, the bolometer of the present embodiment does not necessary require a light reflection layer for reflecting the infrared ray transmitted through the bolometer film, and therefore, the bolometer according to one embodiment of the present invention does not comprise any light reflection layer; however, if desired, a light reflection layer may be provided between the carbon nanotube film 104 and the substrate 101, for example on the substrate 101. However, it is preferred that the light reflection layer is not provided from the view point of simplifying the element structure as described above.

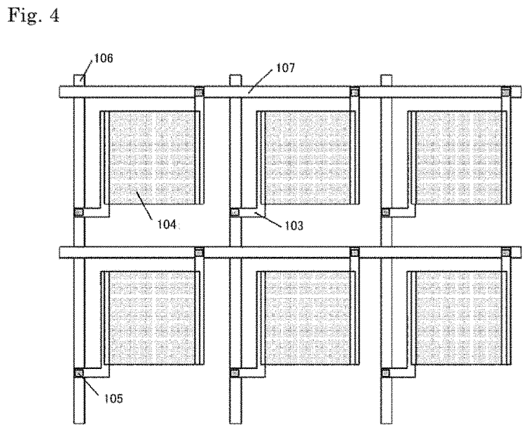

Furthermore, although a bolometer of a single cell (single element) is shown above, a bolometer array can be made by arranging a plurality of elements in an array configuration. FIG. 4 is a plan view showing a bolometer array in which the sensor cells of FIGS. 1A and 1B are arranged in an array configuration. A two-dimensional image sensor can be configured by connecting electrodes 103 of each element to a plurality of column wirings 106 for each column via contacts 105, and to a plurality of row wirings 107 for each row via contacts 105. In such a structure, electrical signals are given to the row wiring 107 and the column wiring 106 corresponding to each cell, and then the resistance change of the cell is read out. An infrared image is obtained by sequentially reading out the resistance changes of all cells.

[2] Elements Constituting Bolometer

Hereinafter, elements constituting the bolometer according to the present embodiment will be each described in detail.

[2-1] Carbon Nanotube Film

The carbon nanotube film 104 is constituted with a plurality of carbon nanotubes forming conductive paths electrically connecting between electrodes. The bolometer of the present embodiment uses a predetermined carbon nanotube film as described below in detail to thereby improve the infrared absorption rate, and as a result, simplification of the bolometer structure and cost reduction in manufacturing process can be achieved.

Semiconducting carbon nanotubes having a large band gap and carrier mobility are preferably used for the carbon nanotube film 104. The proportion of the semiconducting carbon nanotubes in the carbon nanotubes constituting the carbon nanotube film is generally 67% by mass or more, preferably 70% by mass or more, more preferably 80% by mass or more, and in particular, preferably 90% by mass or more, more preferably 95% by mass or more, and further preferably 99% by mass or more (including 100% by mass).

As the carbon nanotubes, single-walled, double-walled, and multi-walled carbon nanotubes may be used, and from the view point of separating semiconducting carbon nanotubes, single-walled or few-walled (for example, double-walled or triple-walled), in particular, single-walled carbon nanotubes are preferred. In the carbon nanotubes constituting the carbon nanotube film, the amount of the single-walled carbon nanotubes is preferably 80% by mass or more, and more preferably 90% by mass or more (including 100% by mass).

The diameter of the carbon nanotubes is preferably between 0.6 and 1.5 nm, more preferably 0.6 nm to 1.2 nm, and further preferably 0.7 to 1.1 nm, and optionally preferably 1 nm or less, from the viewpoint of increasing the band gap to improve TCR. When the diameter is 0.6 nm or more, the manufacture of carbon nanotubes becomes much easier. When the diameter is 1.5 nm or less, the band gap is easily maintained in an appropriate range and a high TCR can be obtained.

As used herein, the diameter of the carbon nanotubes means that when the carbon nanotubes film is observed using an atomic force microscope (AFM) and the diameter thereof is measured at about 50 positions, 60% or more, preferably 70% or more, optionally preferably 80% or more, more preferably 100% thereof is within a range of 0.6 to 1.5 nm. It is preferred that 60% or more, preferably 70% or more, optionally preferably 80% or more, and more preferably 100% thereof be within a range of 0.6 to 1.2 nm, and further preferably within a range of 0.7 to 1.1 nm, and optionally 1 nm or less.

The length of the carbon nanotubes is preferably between 100 nm to 5 μm because dispersion is easy and application properties are excellent. Also, from the viewpoint of conductivity of the carbon nanotubes, the length is preferably 100 nm or more. When the length is 5 μm or less, aggregation upon forming a film is easily suppressed. The length of the carbon nanotubes is more preferably 500 nm to 3 μm, and further preferably 700 nm to 1.5 μm.

As used herein, the length of the carbon nanotubes means that, when at least 50 carbon nanotubes are observed using an atomic force microscope (AFM) and enumerated to measure the distribution of the length of the carbon nanotubes, 60% or more, preferably 70% or more, optionally preferably 80% or more, and more preferably 100% thereof is within a range of 100 nm to 5 μm. It is preferred that 60% or more, preferably 70% or more, optionally preferably 80% or more, and more preferably 100% thereof be within a range of 500 nm to 3 μm, and it is more preferred that 60% or more, preferably 70% or more, optionally preferably 80% or more, and more preferably 100% thereof be within a range of 700 nm to 1.5 μm.

When the diameter and length of the carbon nanotubes are within the above range, the influence of semiconductive properties becomes large and a large current value can also be obtained, and thus, a high TCR value is likely to be obtained when the carbon nanotubes are used in a bolometer.

The thickness of the carbon nanotube film is in the range of, for example, 10 nm to 1 μm, preferably 20 nm to 500 nm, more preferably 50 nm to 200 nm or more.

When the thickness of the carbon nanotube film is 10 nm or more, preferably 50 nm or more, the element structure can be made simpler because an adequate infrared absorption rate is obtained even without comprising an infrared reflection layer or an infrared absorbing layer.

In addition, from the view point of simplifying the manufacturing method, it is preferred that the thickness of the carbon nanotube film is 1 μm or less, preferably 500 nm or less. Also, when the carbon nanotube film is too thick, the contact electrode deposited from above may not fully contact the carbon nanotubes at the bottom side of the carbon nanotube film, and the effective resistance value becomes higher, but when the thickness is within the above range, increase of the resistance value can be suppressed.

Also, in the case of comprising an infrared absorbing layer or the like, it is also possible to make the carbon nanotube film thinner than the above range in order to further simplify the manufacturing process and improve the resistance value.

Also, when the thickness of the carbon nanotube film is in the range of 10 nm to 1 μm as described above, it is also preferable that printing techniques can be suitably applied to the manufacturing method of the carbon nanotube film.

The thickness of the carbon nanotube film can be determined as an average value of the thickness of the carbon nanotube film measured at arbitrary 10 positions.

The density of the carbon nanotube film is, for example, 0.3 g/cm³ or more, preferably 0.8 g/cm³ or more, more preferably 1.1 g/cm³ or more. The upper limit thereof is not particularly limited, and can be the upper limit of the true density of the carbon nanotube used (for example, about 1.4 g/cm³).

When the density of the carbon nanotube film is 0.5 g/cm³ or more, it is preferred that the element structure can be simplified because an adequate infrared absorption rate is obtained even without comprising an infrared reflection layer or an infrared absorbing layer.

Also, when an infrared absorbing layer is comprised, the density of the carbon nanotube film of lower than the above-described density may be appropriately employed.

The density of the carbon nanotube film can be calculated from weight, area, and the thickness obtained as above of the carbon nanotube film.

[2-2] Heat Insulating Layer

The heat insulating layer 102 will be described next. The heat insulating layer 102 is a layer interrupting the heat transmission from the carbon nanotube film 104 to the substrate 101. In the conventional bolometers, a gap is provided to serve as a structure interrupting the heat transmission from a bolometer film to a substrate, and complicated production processes are required to form such a gap. However, since the heat insulating layer in the present embodiment can be formed using a printing process and the like, and complicated production processes are thus not required. In addition, while in the conventional bolometers, the entire element is need to be vacuum packaged in order to keep the gap in vacuum, the bolometer of the present embodiment has an advantage of not requiring such vacuum packaging.

A resin component with a low heat conductivity is preferably used for the heat insulating layer. The heat conductivity of the resin component to be used for the heat insulating layer is lower than the heat conductivity of the substrate 101, and for example, is in the range of 0.02 to 0.3 (W/mK), preferably 0.05 to 0.15 (W/mK). Examples of such resin component include parylene, but not limited thereto. Parylene is a generic term for paraxylene-based polymers, and has a structure in which benzene rings are linked via CH₂. Parylene includes parylene N, parylene C, parylene D, parylene HT and the like, and among them, parylene C (heat conductivity: 0.084 (W/mK)) having the lowest heat conductivity is suitable.

The thickness of the heat insulating layer can be appropriately set in considering the heat conductivity of the component to use, and in a case of using parylene C for example, it is preferably in the range of 5 μm to 50 μm, and more preferably in the range of 10 μm to 20 μm.

It should be noted that when a heat reflection layer is provided to improve the infrared absorption rate, the distance between the carbon nanotube film 104 and the heat reflection layer should be set in considering the wavelength of the infrared ray to absorb, and therefore, the thickness of the heat insulating layer 102 is also limited. However, the bolometer of the present embodiment does not necessary require such heat reflection layer, and therefore has an advantage that the thickness of the heat insulating layer can be configured freely within the range capable of achieving a desired heat insulation property.

As described above, in the bolometer of the present embodiment, the structure (the thickness of the heat insulating layer and the like) is not limited by the wavelength of the electromagnetic wave to be detected, and therefore, it can be used for detecting an electromagnetic wave of a broader wavelength band as compared to the conventional bolometers. The bolometer of the present embodiment using a carbon nanotube film as a bolometer film can be particularly preferably used for detecting an electromagnetic wave having a wavelength of 0.7 μm to 1 mm. The electromagnetic waves included in this wavelength range include, in addition to infrared ray, terahertz wave.

The bolometer of the present embodiment is preferably an infrared sensor.

[2-3] Other Components

In the bolometer of the present embodiment, as a component other than the above-described carbon nanotube film 104 and the heat insulating layer 102, those typically used in a bolometer can be used without limitation, and an example thereof will be described below.

(Substrate)

The substrate 101 may be either a flexible substrate or a rigid substrate, and those in which at least the element forming surface has insulating property or semiconducting property may be used, and in particular, one having an insulating element forming surface is preferred. Examples of the substrate include Si, SiO₂-coated Si, SiO₂, SiN, parylene, plastic and the like, but is not limited thereto.

(Electrode)

The electrode 103 is not limited and for example, gold, platinum, titanium and the like may be used. The thickness of the electrode may be appropriately adjusted and is preferably 10 nm to 1 mm, and more preferably 50 nm to 1 μm. The distance between the electrodes is preferably 1 μm to 500 μm, and for miniaturization, it is more preferably 5 to 200 μm. When the distance is 5 μm or more, a reduction in the nature of TCR can be suppressed, even in the case of containing a small amount of metallic carbon nanotubes. In addition, the distance of 500 μm or less is advantageous when it is applied to an image sensor having a two-dimensional array. The electrode 103 may be provided beneath the carbon nanotube film 104, or may be provided above the carbon nanotube film 104.

(Protection Layer)

When a protection layer 108 is provided as shown in FIG. 2, the protection layer is preferably made of a material having a high transparency in the infrared wavelength range to be detected, and examples thereof include resins used for the above-described heat insulating layer, such as parylene, and also acrylic resins such as PMMA and PMMA anisole, epoxy resins, Teflon (R), silicon nitrate, silicon oxide (SiO₂) and the like, but not limited thereto. The thickness of the protection layer depends on its material, and may be for example 5 nm to 50 nm.

(Infrared Absorbing Layer)

In a case where an infrared absorbing layer 109 is provided as shown in FIGS. 3A and 3B, the infrared absorbing layer 109 to be provided on the protection layer 108 is not limited and examples of which include a thin film of silicon nitrate and the like (FIG. 3A). Also, in a case where an infrared absorbing layer 109 is provided directly on the carbon nanotube film 104, it is not limited but may include a coating film of polyimide and the like (FIG. 3B). The thickness of the infrared absorbing layer depends on its material, and for example, may be from 50 nm to 1 μm.

[3] Method for Manufacturing a Bolometer

The method for manufacturing the bolometer according to the present embodiment is not particularly limited and any method used for manufacturing a bolometer can be appropriately employed. From the view point of simplifying the manufacturing processes and lowering the cost, it is preferred to form a heat insulating layer and a carbon nanotube film on a desired substrate using a printing method or the like.

[3-1] Carbon Nanotube Film

A carbon nanotube dispersion liquid is preferably used for forming the carbon nanotube film. A method for producing a carbon nanotube dispersion liquid to be used for producing a carbon nanotube film, and a film formation method of a carbon nanotube film using a carbon nanotube dispersion liquid will be described below. However, it should be noted that the method for producing a carbon nanotube film is not limited to the following.

From the carbon nanotubes to be used in the carbon nanotube dispersion liquid, surface functional groups and impurities such as amorphous carbon, catalysts, and the like may be removed by performing a heat treatment under an inert atmosphere, or in a vacuum. The heat treatment temperature may be appropriately selected and is preferably 800 to 2000° C., and more preferably 800 to 1200° C.

The carbon nanotube dispersion liquid preferably comprises a nonionic surfactant.

The nonionic surfactant may be appropriately selected, and it is preferred to use nonionic surfactants constituted by a hydrophilic portion which is not ionized and a hydrophobic portion such as an alkyl chain, for example, nonionic surfactants having a polyethylene glycol structure exemplified by polyoxyethylene alkyl ethers, and alkyl glucoside based nonionic surfactants, singly or in combination. As such a nonionic surfactant, polyoxyethylene alkyl ether represented by Formula (1) is preferably used. In addition, the alkyl moiety may have one or a plurality of unsaturated bonds.

CₙH₂ₙ₊₁(OCH₂CH₂)ₘOH (1)

wherein, n=preferably 12 to 18, and m=10 to 100, and preferably 20 to 100.

In particular, a nonionic surfactant specified by polyoxyethylene (n) alkyl ether (wherein n=20 or more and 100 or less, and the alkyl chain length is C12 or more and C18 or less) such as polyoxyethylene (23) lauryl ether, polyoxyethylene (20) cetyl ether, polyoxyethylene (20) stearyl ether, polyoxyethylene (10) oleyl ether, polyoxyethylene (10) cetyl ether, polyoxyethylene (10) stearyl ether, polyoxyethylene (20) oleyl ether, polyoxyethylene (100) stearyl ether is more preferred. In addition, N,N-bis[3-(D-gluconamido)propyl]deoxycholamide, n-dodecyl-D-maltoside, octyl -D-glucopyranoside, and digitonin may also be used.

As the nonionic surfactant, polyoxyethylene sorbitan monostearate (molecular formula: C₆₄H₁₂₆O₂₆, trade name: Tween 60, manufactured by Sigma-Aldrich, etc.), polyoxyethylene sorbitan trioleate (molecular formula: C24E14406, trade name: Tween 85, manufactured by Sigma-Aldrich, etc.), octylphenol ethoxylate (molecular formula: C₁₄H₂₂O(C₂H₄₀)ₙ, n=1 to 10, trade name: Triton X-100, manufactured by Sigma-Aldrich, etc.), polyoxyethylene (40) isooctylphenyl ether (molecular formula: C₈H₁₇C₆H₄₀(CH₂CH₂₀)₄₀H, trade name: Triton X-405, manufactured by Sigma-Aldrich, etc.), poloxamer (molecular formula: C₅H₁₀O₂, trade name: Pluronic, manufactured by Sigma-Aldrich, etc.), polyvinyl pyrrolidone (molecular formula: (C₆H₉NO)ₙ, n=5 to 100, manufactured by Sigma-Aldrich, etc.) may be used.

The molecular length of the nonionic surfactant is preferably 5 to 100 nm, more preferably 10 to 100 nm, and further preferably 10 to 50 nm. When the molecular length is 5 nm or more, in particular, 10 nm or more, the distance between carbon nanotubes can be appropriately held and aggregation is easily suppressed after the dispersion liquid is applied on the electrodes (the region including the region between electrode 1 and electrode 2). The molecular length of 100 nm or less is preferred from the viewpoint of constructing a network structure.

Such a nonionic surfactant has a weak interaction with the carbon nanotubes and can be easily removed after applying a dispersion liquid, and therefore, a stable carbon nanotube conductive network can be formed and an excellent TCR value can be obtained. Since such a nonionic surfactant has a long molecular length, the distance between the carbon nanotubes becomes large at the time of applying a dispersion liquid, and the carbon nanotubes are less likely to re-aggregate. Thus, a carbon nanotube network in an isolated and dispersed state can be formed while keeping a moderate interval, and a large resistance change can be achieved against temperature change.

The method for obtaining a dispersion solution is not particularly limited, and conventionally known methods can be applied. For example, a carbon nanotube mixture, a dispersion medium, and a nonionic surfactant are mixed to prepare a solution containing carbon nanotubes, and this solution is subjected to sonication to disperse the carbon nanotubes, thereby preparing a carbon nanotube dispersion liquid (micelle dispersion solution). The dispersion medium is not particularly limited, as long as it is a solvent that allows carbon nanotubes to disperse and suspend during the separation step, and for example, water, heavy water, an organic solvent, an ionic liquid, or a mixture thereof may be used, and water and heavy water are preferred. In addition to or instead of the sonication mentioned above, a technique of dispersing carbon nanotubes by a mechanical shear force may be used. The mechanical shearing may be performed in a gas phase. In a micelle dispersion aqueous solution of the carbon nanotubes and the nonionic surfactant, the carbon nanotubes are preferably in an isolated state. Thus, if necessary, bundles, amorphous carbon, impurity catalysts, and the like may be removed using an ultracentrifugation treatment. During the dispersion treatment, the carbon nanotubes can be cut, and the length thereof can be controlled by changing the grinding conditions of the carbon nanotubes, ultrasonic output, ultrasonic treatment time, and the like. For example, the aggregate size can be controlled by grinding the untreated carbon nanotubes using tweezers, a ball mill, or the like. After these treatments, the length can be controlled to 100 nm to 5 μm using as ultrasonic homogenizer by setting the output to 40 to 600 W, optionally 100 to 550 W, 20 to 100 KHz, the treatment time to 1 to 5 hours, preferably up to 3 hours. When the treatment time is shorter than 1 hour, the carbon nanotubes may be hardly dispersible depending on the conditions, and may remain almost the original length in some cases. From the viewpoint of shortening the dispersion treatment time and reducing the cost, the treatment time is preferably 3 hours or less. The present embodiment may also have the advantage of ease of adjustment of cutting due to use of a nonionic surfactant. In addition, the infrared sensor according to the present embodiment manufactured by using the carbon nanotubes prepared by a method using a nonionic surfactant has the advantage of containing no ionic surfactant which is difficult to be removed.

Dispersion and cutting of the carbon nanotubes generate a surface functional group at the surface or the end of the carbon nanotube. Functional groups such as carboxyl group, carbonyl group, and hydroxyl group are generated. When the treatment is performed in a liquid phase, a carboxyl group and a hydroxyl group are generated, and when the treatment is performed in a gas phase, a carbonyl group is generated.

The concentration of the surfactant in the liquid comprising heavy water or water and a nonionic surfactant mentioned above is preferably from the critical micelle concentration to 10% by mass, and more preferably from the critical micelle concentration to 3% by mass. The concentration less than the critical micelle concentration is not preferred because dispersion is impossible. When the concentration is 10% by mass or less, a sufficient density of carbon nanotubes can be applied after separation, while reducing the amount of surfactant. As used herein, the critical micelle concentration (CMC) refers to the concentration serving as an inflection point of the surface tension measured by, for example, changing the concentration of an aqueous surfactant solution using a surface tensiometer such as a Wilhelmy surface tensiometer at a constant temperature. As used herein, the “critical micelle concentration” is a value under atmospheric pressure at 25° C.

The concentration of the carbon nanotubes in the above cutting and dispersion step (the weight of the carbon nanotubes/(the total weight of the carbon nanotubes, the dispersion medium and the surfactant)×100) is not particularly limited, and for example, may be 0.0003 to 10% by mass, preferably 0.001 to 3% by mass, and more preferably 0.003 to 0.3% by mass.

The dispersion liquid obtained through the above cutting and dispersion step may be used as it is in the separation step described below, or a step of concentration, dilution, or the like may be performed before the separation step. The centrifugation treatment may be performed to remove the bundles, amorphous carbon, metal impurities, and the like in the carbon nanotube dispersion liquid before the separation step. The centrifugal acceleration may be appropriately adjusted, and is preferably 10000×g to 500000×g, more preferably 50000×g to 300000×g, and optionally 100000×g to 300000×g. The centrifugation time is preferably 0.5 hours to 12 hours, and more preferably 1 to 3 hours. The centrifugation temperature may be appropriately adjusted, and is preferably 4° C. to room temperature, and more preferably 10° C. to room temperature.

Separation of the semiconducting carbon nanotubes and the metallic carbon nanotubes can be performed by, for example, the electric-field-induced layer formation method (ELF method: see, for example, K. Ihara et al. J. Phys. Chem. C. 2011, 115, 22827 to 22832 and Japanese Patent No. 5717233, which are incorporated herein by reference). One example of the separation method using the ELF method will be described. Carbon nanotubes, preferably single-walled carbon nanotubes are dispersed by a nonionic surfactant, and the dispersion liquid is put into a vertical separation apparatus, and then a voltage is applied to the electrodes arranged above and below, so that the carbon nanotubes are separated by free flow electrophoresis. The mechanism of separation can be inferred as follows. When the carbon nanotubes are dispersed by the nonionic surfactant, the micelle of the semiconducting carbon nanotubes has a negative zeta potential, whereas the micelle of the metallic carbon nanotubes has an opposite (positive) zeta potential (in recent years, it is considered that the metallic carbon nanotubes have a slightly negative zeta potential or are barely charged). Thus, when an electric field is applied to the carbon nanotube dispersion liquid, the micelle of the semiconducting carbon nanotubes is electrophoresed toward the anode (+) direction, and the micelle of the metallic carbon nanotubes is electrophoresed toward the cathode (−) direction by the effects of the difference between the zeta potentials, and the like. Eventually, the layer in which the semiconducting carbon nanotubes are concentrated is formed near the anode, and the layer in which the metallic carbon nanotubes are concentrated is formed near the cathode in the separation tank. The voltage for separation may be appropriately set in consideration of the composition of the dispersion medium, the charge amount of carbon nanotubes, and the like, and is preferably 1 V or more and 200 V or less, and more preferably 10 V or more and 200 V or less. It is preferably 100 V or more from the viewpoint of shortening the time for the separation step. It is preferably 200 V or less from the viewpoint of suppressing the generation of bubbles during separation and maintaining the separation efficiency. The purity is improved by repeating separation. The same separation procedure may be performed by resetting the dispersion liquid after separation to the initial concentration. As a result, the purity can be further increased.

Through the aforementioned dispersion and cutting step and separation step of the carbon nanotubes, a dispersion liquid in which the semiconducting carbon nanotubes having the desired diameter and length are concentrated can be obtained. As used herein, the carbon nanotube dispersion liquid in which semiconducting carbon nanotubes are concentrated to a desired ratio may be referred to as the “semiconducting carbon nanotube dispersion liquid”. The separation tendency of the metallic and semiconducting carbon nanotubes can be analyzed by microscopic Raman spectroscopy and ultraviolet-visible near-infrared absorptiometry.

The zeta potential of the semiconducting carbon nanotube dispersion liquid is preferably +5 mV to −40 mV, more preferably +3 mV to −30 mV, and further preferably +0 mV to −20 mV. The zeta potential of +5 mV or less is preferred because it means that the content of the metallic carbon nanotubes is low. If the zeta potential is lower than −40 mV, separation is difficult in the first place. Here, the zeta potential of the semiconducting carbon nanotube dispersion liquid refers to the zeta potential of the semiconducting carbon nanotube dispersion liquid containing a nonionic surfactant and the micelle of the semiconducting carbon nanotubes obtained through, for example, the separation step by the above ELF method. As used herein, the zeta potential of the carbon nanotube dispersion liquid is a value obtained by measuring the dispersion liquid using an ELSZ apparatus (Otsuka Electronics Co., Ltd.)

The carbon nanotube film can be formed by applying the semiconducting carbon nanotubes dispersion liquid obtained by the aforementioned method on the aforementioned heat insulating layer, and drying the resultant. Alternatively, the semiconducting carbon nanotubes dispersion liquid may be applied on a desired substrate to form a film, and the resulting carbon nanotube film may be layered on the aforementioned heat insulating layer.

The concentration of the surfactant in the carbon nanotube dispersion liquid after separation which is used for the application may be appropriately controlled. The concentration of the surfactant in the carbon nanotube dispersion liquid upon application to the substrate is preferably from the critical micelle concentration to about 5% by mass, more preferably, 0.001% by mass to 3% by mass, and particularly preferably 0.01 to 1% by mass to suppress the reaggregation after application and the like.

The method for applying the carbon nanotube dispersion liquid is not particularly limited, and examples thereof include dropping method, spin coating, printing, spray coating, dip coating, and the like. From the viewpoint of reducing the manufacturing cost, a printing method is preferred. The printing methods can include application (dispenser, inkjet or the like), transferring (microcontact print, gravure printing, or the like) and the like.

The carbon nanotubes formed into a film may be subjected to a heat treatment to remove the surfactant and the solvent. The temperature of the heat treatment may be appropriately set as long as it is equal to or higher than the decomposition temperature of the surfactant, and it is preferably 150 to 400° C., and more preferably 200 to 400° C. A temperature of 200° C. or more is preferred because the remaining of the decomposition product of the surfactant can be easily suppressed. A temperature of 400° C. or less is preferred because the change in the quality of the substrate can be suppressed. Also, the decomposition of carbon nanotubes, the change in size, the leaving of functional groups, and the like can be suppressed.

[3-2] Heat Insulating Layer

The manufacturing method of the heat insulating layer is not particularly limited as long as the method can produce the heat insulating layer described above. For example, when a parylene film is used as the heat insulating layer, the parylene film can be formed by coating a desired area with parylene using a vacuum vapor deposition apparatus. Specifically, when solid dimer is heated under vacuum, it vaporizes to become dimer gas. This gas is thermally decomposed and the dimer is cleaved to a monomer form. In the vapor deposition chamber at room temperature, this monomer gas polymerizes on all surfaces to form a thin, transparent polymer film.

If necessary, pre-treatment of the substrate, cleaning of the substrate, and masking of the areas that should not be deposited may be performed before the vapor deposition process is performed.

[3-3] Structure and Manufacturing Method of Bolometer and Bolometer Array

An example of the structure and the manufacturing method of a bolometer and a bolometer array will be described with reference to the figures, but the structure and the manufacturing method of the bolometer array are not limited thereto.

### EXAMPLE 1

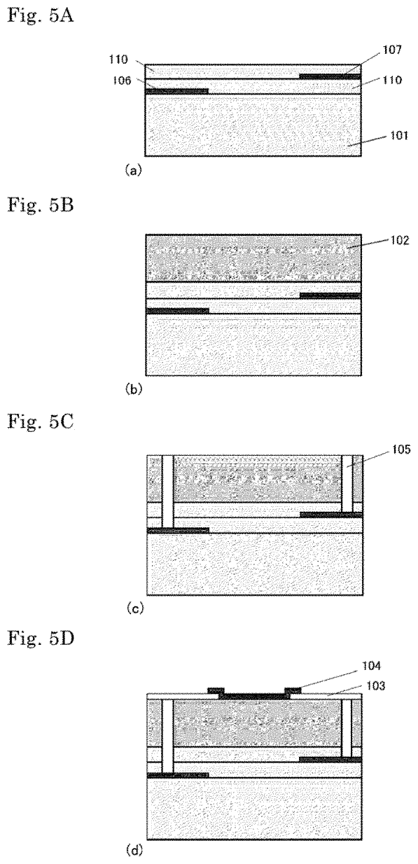

In FIG. 5A, an aluminum film (1000 Å) is vapor-deposited on substrate 101 through a metal mask to form column wiring 106. Then, insulating film 110 is formed by applying polyimide. Row wiring 107 is formed thereon in a same manner as the column wiring. Further, the second insulating film 110 is formed by applying polyimide thereon.

Next, as shown in FIG. 5B, as heat insulating layer 102, a parylene film is formed with, for example, a thickness of about 20 μm by vapor deposition. Parylene is usually in a dimer state, and is heated to about 700° C. in a vapor deposition apparatus to becomes a monomer state, and then becomes a polymer state after being vapor-deposited on the substrate.

Then, as shown in FIG. 5C, contact holes 105 are opened by lithography and dry etching.

Then, as shown in FIG. 5D, electrodes 103 each connected to the row wiring and column wiring via contact holes 105 are formed. A lithography and a lift-off method can be used as the formation method. The electrode 103 may be formed by vapor deposition or printing method. The electrode 103 may also be formed after carbon nanotube film 104 is formed.

Thereafter, carbon nanotube film 104 is formed. Carbon nanotube film 104 is preferably formed by a printing method, for example, by applying the carbon nanotube dispersion liquid described above by a dispenser apparatus. Here, the thickness and the density of the carbon nanotube film are, for example, the thickness of 100 nm and the density of 1.1 g/cm³, respectively.

If a protective film 108 is to be provided in addition to the above components, for example, a protection layer can be formed by applying a resin solution used for the protection layer on the formed carbon nanotube film 104. Thereafter, the entire substrate may be subjected to an oxygen plasma treatment to remove excess carbon nanotube and the like present in the areas other than carbon nanotube film 104.

If an infrared absorbing layer 109 is to be provided in addition to the above components, it may be formed on the above carbon nanotube film 104 or protective film 108 using a printing method or the like, or an infrared absorbing layer formed in advance may be layered or transferred.

### EXAMPLE 2

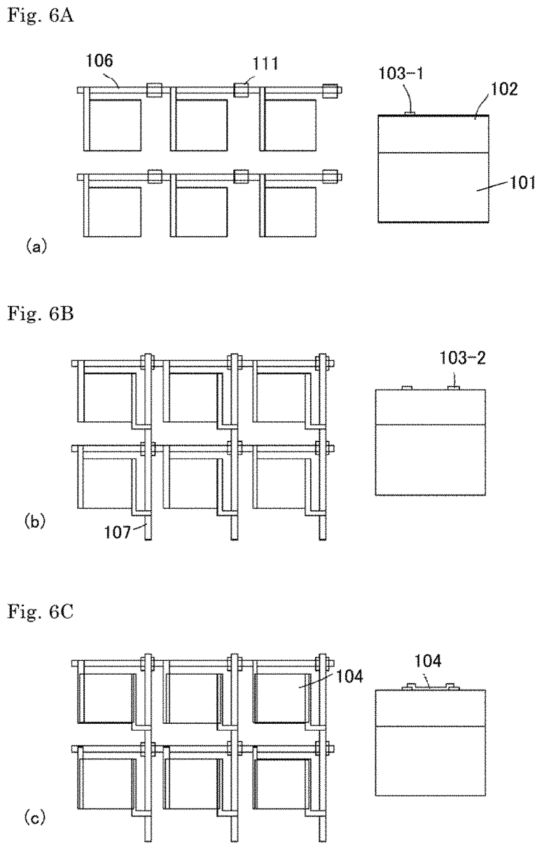

Another example will be explained with reference to FIGS. 6A to 6C.

First, as shown in FIG. 6A, heat insulating layer 102 is formed on substrate 101, and first electrode 103-1 and column wiring 106 are formed thereon. The first electrode and the column wiring can be made of the same material and formed simultaneously by vapor deposition or a printing method.

Next, insulating film 111 is formed to insulate a part of row wiring 106 that intersects with a row wiring in a later process. A method of forming the insulating film includes coating polyimide to form a film using a printing method.

Next, as shown in FIG. 6B, second electrode 103-2 and row wiring 107 are formed in a same manner as the first electrode and the column wiring.

Next, as shown in FIG. 6C, carbon nanotube film 104 connected with the first and second electrodes is formed.

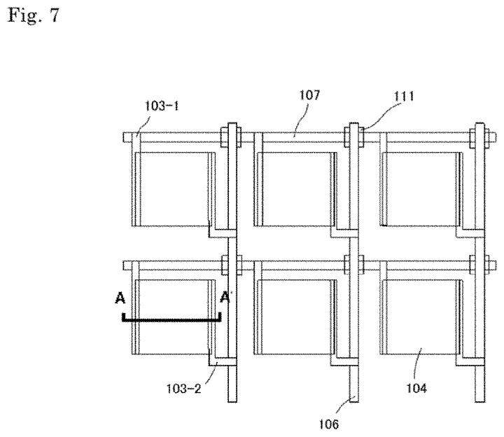

According to such a method, a bolometer array as shown in FIG. 7 can be manufactured using a printing process and the like without performing a contact formation, which enables further cost reduction.

### EXAMPLE 3

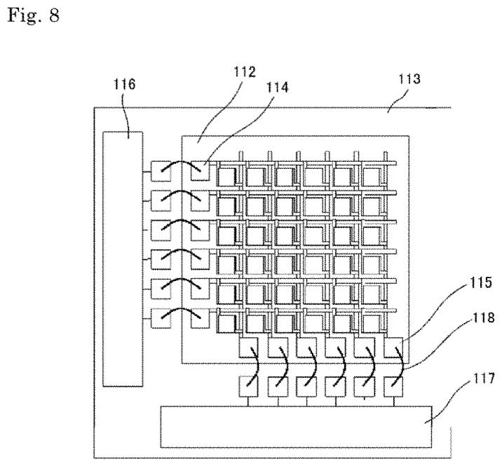

Another example will be explained with reference to FIG. 8.

In the bolometer array of FIG. 8, a bolometer array is formed on first substrate 112, such as a resin substrate, and a readout circuit is formed on second substrate 113, which is a semiconductor substrate, using an ordinary silicon CMOS process (not shown). An insulating layer is formed on the readout circuit, and the first substrate is attached on the second substrate. The bolometer array of the present embodiment can be formed by electrically connecting column terminals 114 and row terminals 115 of the first substrate to the terminals leading to column selecting circuit 116 and row selecting circuit 117 in the readout circuit on the second substrate using bonding wires 118 or the like.

### EXAMPLE 4

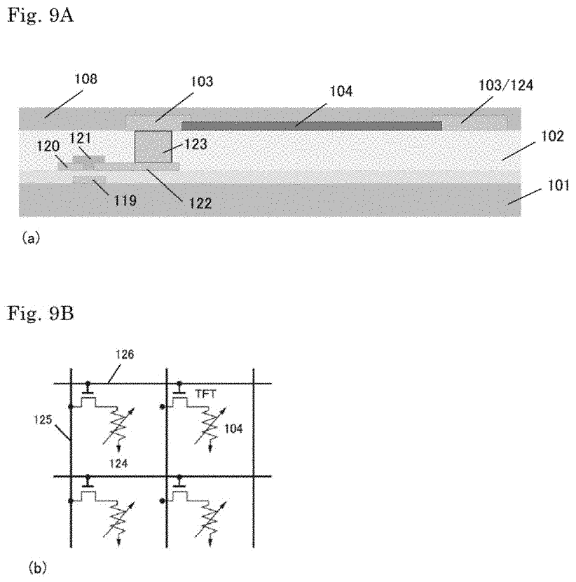

Another example will be explained with reference to FIGS. 9A and 9B.

A TFT (thin-film transistor) array is also preferably applied to the array sensor according to the present embodiment. The application of a TFT array makes possible high-speed scanning. The form of the TFT array is not particularly limited, and one example thereof is shown in FIGS. 9A and 9B. In the TFT array shown in FIG. 9A, gate electrode 119 is placed on substrate 101, and source electrode 120 and drain electrode 122 are formed on the upper layer thereof with an insulating layer therebetween. Heat insulating layer 102, carbon nanotube film 104, and protective film 108 are formed on the upper layer thereof. Drain electrode 122 is connected to pixel electrode 103, which is formed in contact with the carbon nanotube film 104, through via 123 that extends through heat insulating layer 102. The other electrode 103 is connected to common electrode 124. The two-dimensional arrangement of the pixel circuit of this TFT array is shown in FIG. 9B.

While the invention has been described with reference to example embodiments and examples thereof, the invention is not limited to these embodiments and examples. Various changes that can be understood by those of ordinary skill in the art may be made to form and details of the present invention without departing from the spirit and scope of the present invention.

### Supplementary Note

The whole or part of the example embodiments disclosed above can be described as, but not limited to, the following supplementary notes.
(Supplementary note 1) A bolometer comprising:

a substrate;

a heat insulating layer formed on the substrate; and

a bolometer film formed on the heat insulating layer; wherein

the bolometer film is a carbon nanotube film comprising semiconducting carbon nanotubes in an amount of 67% by mass or more of the total amount of carbon nanotubes, and

the thickness of the carbon nanotube film is in the range of 10 nm to 1 μm, and the density of the carbon nanotube film is 0.3 g/cm³ or more.
(Supplementary note 2) The bolometer according to the supplementary note 1, comprising no light reflection layer.
(Supplementary note 3) The bolometer according to the supplementary note 1 or 2, wherein 60% or more of the carbon nanotubes contained in the carbon nanotube film have a diameter within the range of 0.6 to 1.5 nm and a length within the range of 100 nm to 5 m.
(Supplementary note 4) The bolometer according to any one of the supplementary notes 1 to 3, wherein the carbon nanotube film comprises the semiconducting carbon nanotubes in an amount of 90% by mass or more of the total amount of carbon nanotubes.
(Supplementary note 5) The bolometer according to any one of the supplementary notes 1 to 4, wherein the heat conductivity of the heat insulating layer is in the range of 0.02 to 0.3 W/mK.
(Supplementary note 6) The bolometer according to any one of the supplementary notes 1 to 5, wherein the heat insulating layer is a parylene film.
(Supplementary note 7) The bolometer according to any one of the supplementary notes 1 to 6, further comprising a protection layer.
(Supplementary note 8) The bolometer according to any one of the supplementary notes 1-7, comprising no light absorbing layer.
(Supplementary note 9) The bolometer according to any one of the supplementary notes 1-8, which is a bolometer array in which a plurality of elements comprising a carbon nanotube film is formed on a substrate.
(Supplementary note 10) A method for manufacturing a bolometer comprising

forming a heat insulating layer on a substrate, and

forming a bolometer film on the heat insulating layer; wherein

the bolometer film is a carbon nanotube film comprising semiconducting carbon nanotubes in an amount of 67% by mass or more of the total amount of carbon nanotubes, and

the thickness of the carbon nanotube film is in the range of 10 nm to 1 μm, and the density of the carbon nanotube film is 0.3 g/cm³ or more.

### EXPLANATION OF REFERENCE

101 Substrate
102 Heat insulating layer
103 Electrode
104 Bolometer film
105 Contact
106 Column wiring
107 Row wiring
108 Protection layer
109 Infrared absorbing layer
110 Insulating film
111 Insulating film
112 First substrate
113 Second substrate
114 Column terminal
115 Row terminal
116 Column selecting circuit
117 Row selecting circuit
118 Bonding wire
119 Gate electrode
120 Source electrode
121 Semiconductor
122 Drain electrode
123 Via
124 Common electrode
125 Source line
126 Gate line
1 Base substrate
3 Infrared detection part
4 Heat insulating unit
6 Infrared reflection film
7 Gap
42 Leg
801 Semiconductor substrate
804 Infrared reflection film
805 Metal electrode
806 Thermistor resistor
811 Infrared absorbing structure
820 Interlayer insulating film
830 Sacrificial layer
831 Silicon nitride film
832 Silicon oxide film
833 Second silicon nitride film

1. A bolometer comprising:
a substrate;
a heat insulating layer formed on the substrate; and
a bolometer film formed on the heat insulating layer; wherein
the bolometer film is a carbon nanotube film comprising semiconducting carbon nanotubes in an amount of 67% by mass or more of the total amount of carbon nanotubes, and
the thickness of the carbon nanotube film is in the range of 10 nm to 1 μm, and the density of the carbon nanotube film is 0.3 g/cm³ or more.

2. The bolometer according to claim 1, comprising no light reflection layer.

3. The bolometer according to claim 1, wherein 60% or more of the carbon nanotubes contained in the carbon nanotube film have a diameter within the range of 0.6 to 1.5 nm and a length within the range of 100 nm to 5 μm.

4. The bolometer according to claim 1, wherein the carbon nanotube film comprises the semiconducting carbon nanotubes in an amount of 90% by mass or more of the total amount of carbon nanotubes.

5. The bolometer according to claim 1, wherein the heat conductivity of the heat insulating layer is in the range of 0.02 to 0.3 W/mK.

6. The bolometer according to claim 1, wherein the heat insulating layer is a parylene film.

7. The bolometer according to claim 1, further comprising a protection layer.

8. The bolometer according to claim 1, comprising no light absorbing layer.

9. The bolometer according to claim 1, which is a bolometer array in which a plurality of elements comprising a carbon nanotube film is formed on a substrate.

10. A method for manufacturing a bolometer comprising
forming a heat insulating layer on a substrate, and
forming a bolometer film on the heat insulating layer; wherein
the bolometer film is a carbon nanotube film comprising semiconducting carbon nanotubes in an amount of 67% by mass or more of the total amount of carbon nanotubes, and
the thickness of the carbon nanotube film is in the range of 10 nm to 1 μm, and the density of the carbon nanotube film is 0.3 g/cm³ or more.
